(19) United States
(12) Patent Application Publication
(10) Pub. No.: US 2020/0139404 A1
(43) Pub. Date: May 7, 2020

(54) RAYLEIGH WAVE POSITIONING SYSTEM (RAPS)

(71) Applicant: INDIAN INSTITUTE OF TECHNOLOGY MADRAS (IIT MADRAS), Chennai (IN)

(72) Inventor: Krishnan Balasubramaniam, Chennai (IN)

(73) Assignee: INDIAN INSTITUTE OF TECHNOLOGY MADRAS (IIT MADRAS), Chennai (IN)

(21) Appl. No.: 16/628,781

(22) PCT Filed: Jul. 21, 2018
(86) PCT No.: PCT/IN2018/050474

§ 371 Date: Jan. 6, 2020

(30) Foreign Application Priority Data
Jul. 24, 2017 (IN) 201741026219

(51) Int. Cl. B06B 3/04; G01N 29/24

(52) U.S. Cl. CPC B06B 3/04; G01N 2291/0425; G01N 2291/0423; G01N 29/2462

(57) ABSTRACT

The invention relates to a system which provides a real time update on an estimated positioning of an ultrasonic which is having an ultrasonic generator placed near the inspection probe in the 3D surface, which generates an ultrasonic guided wave travelling along the surface of 3D component and includes positioning more than one ultrasonic receiver probes along the length of 3D component.

### FIELD OF THE INVENTION

The proposed technology uses ultrasonic guided waves such as Rayleigh waves that can travel on the surface of the pipes to provide a novel and new approach to position sensor on complicated geometrical components such as pipelines. This positioning system will provide a real-time update on the estimated positioning of an ultrasonic inspection probe in a 3D surface of the part. The triangulation algorithm/system operates similar to most GPS systems. Here, an ultrasonic guided wave in the form of a Rayleigh (Surface hugging) wave mode is generated in an “omni-direction” manner. This generator is co-located along with the ultrasonic inspection probe and is excited using a simple electronic circuit that generated a time limited sinusoidal/square wave pattern. The wave travels along the surface of the pipe and is detected by 2-6 or more optimally located receiver probes. Using the relative time of arrival of the waves in the received probes, and by knowing the Rayleigh velocity in the case of Rayleigh guided waves and the geometry of the pipe, the position of the transmitter will be determined. The receiver probes are physically attached to the surface of the pipe and at locations that are optimized apriori. Additionally, a simplified calibration procedure will be developed in order to compensate for any variations in the velocity of the Rayleigh waves (guided wave) due to environmental conditions. The overall manufacturing cost of the sensor system will be approximately $500-$700 which is significantly less compared to other similar positioning systems.

### BACKGROUND AND PROBLEMS IN PRIOR ART

Manual ultrasonic field inspection of components such as pipeline systems (including bends and joints) require the probe to be position at a controlled position that must be monitored in order to provide the correct diagnosis on the state of the pipeline component. The techniques employed for several other similar positioning applications such as GPS, Video monitoring, magnetic positioning systems, etc., find limitations when applied to the pipeline components. The limitations are due to the (a) presence of blind spots for RF and Visual techniques and (b) the interference of the fields as well as dynamic flux effects from the metal components when using RF and magnetic methods.

Overcoming these limitations for applications in pipelines may be possible with appropriate designs and instrumentation. However, this will come at a cost that is not realistic for such applications.

Hence, alternative approach is necessary to improve the current manual inspection process through an innovative mode.

### OBJECTS OF THE INVENTION

Here, the use of the surface of the components as mechanisms to transport ultrasonic waves of the Rayleigh mode kind and by using the apriori information regarding the geometry of the pipeline component a novel positioning system that is cost-effective is being proposed. The estimated manufacturing cost of this system is expected to be attractive. In addition, this will have other advantages such as (a) use of ultrasound generators and receivers that are non-ionising and hence inherently safe, (b) no interferences from adjacent structures including the operator or the ultrasonic instrument, (c) low footprint with the transmitters and receivers all positioned on the pipeline component, (c) minimal training requirements since operators are already trained in ultrasound inspection, (d) low power requirements (battery operated) and (e) Modular and configurable modules providing flexibility during implementation. The approach is a simple concept with robustness designed in the mechanical and electronics. In addition, a software providing the 3D location information on the pipe component can also be included to assist the operator in hard to reach conditions where the operator does not have visual line of sight (such as crevices, bottom side inspection of pipes close to the ground, etc).

### 1. BRIEF DESCRIPTION OF THE PREFERRED EMBODIMENT/SAND ITS WORKING IDF:I571

a. Mechanical: For the Purposes of this Provisional Specification, the Mechanical Design
will be limited to (a) the design of the transmitter and receiver probes and (b) the estimation of optimal positioning of the receiver probes for a given pipeline component that is being inspected.

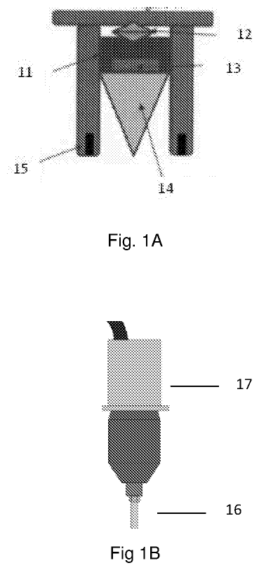

i) Probe Design
The transmitter and the receiver probes are mechanically identical or they may be different, but will definitely have differences in the electronics and the PZT types used. The diagram for the probe (transmitter or receiver) is provided below in FIG. 1. The probe is either a mechanical or a PZT crystal based transducer that generates ultrasonic waves. These waves are transmitted into a conical waveguide in one form of embodiment of the source. The end of the waveguide may be pointed or annular depending on the nature of the requirement. The waves will manifest a point source or a annular line source on the component. The coupling is pressure coupling that is assisted by both magnetic and spring forces that are designed into the probe holder.

Part numbers referred in the drawings:

FIG. 1A

| Part number | Part name |
|---|---|
| 11 | Transducer Backing |
| 12 | Springs |
| 13 | PZT crystal |
| 14 | Conical waveguide |
| 15 | Magnet |

FIG. 1B

| Part number | Part name |
|---|---|
| 16 | Impactor |
| 17 | Actuator |

FIG. 1A: Preliminary design of the transmitter/receiver probe

The electronics is packaged on the top of the probe holder. The transmitter is powered through a cable that is similar to the one used for the ultrasonic inspection system and can be co-located with the ultrasonic inspection instrumentation. The receiver probes are un-tethered and communicate via a wireless protocol and are battery operated. Typical power requirements for the receiver will be similar to a cell phone battery. Other options such as Li-Polymer batteries can also be utilized.

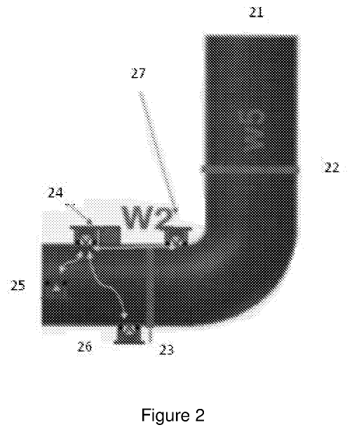

ii) Probe Locations and Position Sensing Algorithm
The positioning of the probe will depend on the type of inspection being performed and the geometry of the component. A calibration procedure and an optimal sensor location procedure will be provided to the operator based on the calculations performed apriori by using a software module is developed as one of the tasks during development of this positioning system. A parameterized version of the automated software is provided, to the manager of the NDT team, to assist and configure the probe location and calibration protocol. The instruction may be downloaded to a handheld unit or provided in printed form to the operator.
A typical probe location diagram (in 2D) is provided in FIG. 2 below. Here only 3 receivers are employed. However, certain components such as elbows and T-joints may require 4 receivers to provide redundancies in measurement and to improve reliability of positioning.

FIG. 1B: Preliminary design of the transmitter/receiver probe which is the other embodiment of probe where the acoustic/ultrasonic wave is generated using a mechanical means such as a impactor that is actuated by say a physical or electro-mechanical means.

FIG. 2: A schematic representation of the Rayleigh wave position sensing system on a typical pipeline component.

| Part number | Part name |
|---|---|
| 21 | Pipe |
| 22 | Weld |
| 23 | Weld under |
| 24 | Transmitter probe collected with |
| | ultrasonic Inspection probe |
| 25 | Receiver 1 |
| 26 | Receiver 2 |
| 27 | Receiver 3 |

The typical frequency of the ultrasonic wave will be of the order of I MHz in order to be insensitive any variations at the surface such as to surface roughness. The wavelength of the Rayleigh wave at this frequency is of the order of 3 mm. The typical distances between the transmitter the receiver will be between 100 mm to 1000 mm depending on the diameter and geometry of the pipe. However, for different type of pipe configurations, the frequency and other parameters may have to be selected for optimal performance. Due to the low attenuation of Rayleigh waves, the distance of propagation of the wave is significantly high and hence pipe diameters of the order of 42 inch can also be included under the scope of this sensing system.

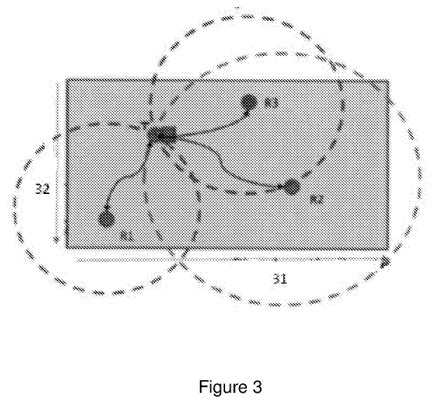

The algorithm for position sensing is an adaptation of the triangulation approach. However, due to curvature effects, the path of the wave must be computed with compensation for the curvature. The positioning is performed by measuring the time of flight between the transmitter and receivers. The resolution of the time of flight measurement will determine the position resolution. Currently, resolutions of the order of I ns is feasible at relatively low cost and hence will be the target for the current version of the position sensor system. A typical triangulation algorithm is schematically represented in FIG. 3 below.

FIG. 3: A schematic representation of the positioning algorithm based on 3 receivers. The pipe has been unwrapped for representing in 2D mode here.

| Part number | Part name |
|---|---|
| 31 | Pipe length direction |
| 32 | Circumferential |

b. Electronics

The electronics will comprise of 3 modules (a) Transmitter, (b) Receiver, and (c) the based module for the position calculations. A schematic diagram of the 3 modules is shown below.

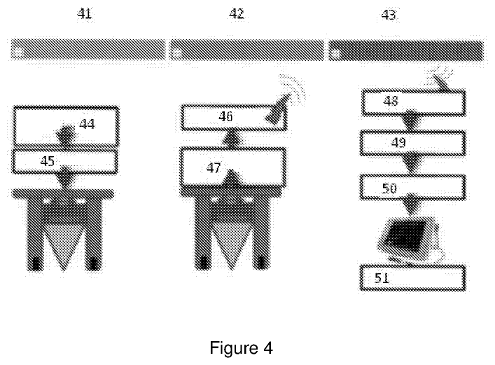

FIG. 4: Electronics modules representation

| Part number | Part name |
|---|---|
| 41 | Transmitter probe |
| 42 | Receiver probe |
| 43 | Base module |
| 44 | Signal generator |
| 45 | Amplifier |
| 46 | RF Transmitter |
| 47 | Filter & Pre-Amp |
| 48 | RF receiver |
| 49 | Filter & A/D |
| 50 | Microprocessor |
| 51 | NDT |

c. Software/Communications

The software will implement the modified triangulation algorithm on a micro-processor. The front end is a C++ code with .NET mode software and the back end is dependent on the microprocessor used here. Additionally, a communication interface is developed to interface the output of the position system to the target NOT system such as the MENTOR NOT instrument.

d. Capabilities of the Design
i. Accuracy: 0.5 mm
ii. Range: 1 m×1 m×1 M
iii. Resolution Target to be 1 mm×1 mm resolution
iv. Sensitivity: N/A

When the incident wave encounters a discontinuous edge, the diffracted waves propagate like a cone.

Anamolies act as low pass filters. The Rayleigh wave measured behind the slot comprises two components. One related to the Rayleigh wave generated in front of the slot and another formed because of the slot. The depth of discontinuities can be inferred from the frequencies that are filtered.

The timing of transmitted waves and reflected waves give information of the depth of a surface discontinuity.

The principle is Rayleigh wave propagates along a surface profile. So one can find the crack length by measuring the difference in the time of flight between two transducers. The time taken without a crack is less than the time taken with a crack.

When an ultrasonic Rayleigh wave encounters a surface discontinuity, the interaction in complex. In addition to transmitted and reflected surface Rayleigh waves, body waves like P waves and S waves are also generated and they, in turn reflect and mode convert at subsequent reflection surface and scatter sources. These body waves do not consist of just one P and one S waves. On the contrary, every discontinuity near the surface becomes a source that generates body and/or surface waves.

The transmitted waves can be used to predict the size of shallow surface cracks. The incident Rayleigh waves can be chopped into two parts by a surface discontinuity. Because the penetrating depth of a Rayleigh wave is proportional to its wavelength, the deep or low frequency part of an incident Rayleigh wave may be deeper than the crack and will be affected differently than the shallower or higher frequency components. If this deeper part of incident Rayleigh wave is chopped and separated from the near surface portion of the incident wave and the two parts can be separated, then their frequency contents hold information on the depth. By separating the various components of the transmitted waves, and finding their properties, one can use this information to predict the depth of surface cracks.

In one aspect the invention relates to a positioning system for providing a real time update on the estimated positioning of an ultrasonic probe in a 3D component. It has a positioning an ultrasonic generator near an inspection probe in the 3D surface. It also includes generating an ultrasonic guided wave in the generator in the form of guided wave mode which is generated in an omni-direction which guided waves travel along the surface of the 3D component. It needs to have positioning of plurality of ultrasonic receiver probes along the length of the 3D component at specific points based on a selective calculation of optimized apriori. With this arrangement the system is operable on real time basis.

In another aspect, the most preferred guided waves is Rayleigh waves as it is most suited for surface transport.

In another aspect, the said receiver probes are magnetically attached to the surface of the pipe.

In another aspect, the transmitter probes are mechanically identical to receiver probes.

In another aspect, the transmitter probes are mechanically not identical to receiver probes.

In another aspect, the electronics in transmitter probes are different from the electronics in receiver probes.

In another aspect, the PZT crystal in transmitter probes are different from the PZT crystal in receiver probes.

In another aspect, the probes are adapted such that the waves are transmitted into a conical wave guide and the end of the wave guide is either pointed or annular.

In another aspect, the probe transmits waves which will manifest a point source or an annular line source on the component.

The description above has been given with the most preferred guided waves i.e., Rayleigh waves but the invention is not restricted to Rayleigh Guided waves and can be extended to other type of guided waves such as Lamb Guided modes, interface guided modes, etc. The commonality between the selected guided waves is the capacity to travel along the surface/geometry which is typically exhibited in ultrasonic guided waves and can be received at multiple points on the surface of the component and may be of relatively lower range of frequencies and will depend on the shape and size of the impactor.

The description has been given with respect to preferred embodiments only for the purpose of understanding and for disclosing the objects and enabling of the invention and is not restricted by the same. All variations and modifications obvious and identifiable by skilled person are part of this specification. The applicant will also rely on the provisional specification and drawings as part of this specification.

We claim:

1. A positioning system for providing a real time update on the estimated positioning of an ultrasonic probe in a 3D component.
positioning an ultrasonic generator near an inspection probe in the 3D surface.
generating an ultrasonic guided wave in the generator in the form of guided wave mode which is generated in an “omni-direction” which guided waves travel along the surface of the 3D component.
positioning a plurality of ultrasonic receiver probes along the length of the 3D component at specific points based on a selective calculation of optimized apriori.

2. The positioning system as claimed in claim 1, wherein the most preferred guided waves is Rayleigh waves.

3. The positioning system as claimed in claim 1, wherein the said receiver probes are magnetically attached to the surface of the pipe.

4. The positioning system as claimed in claim 1, wherein the transmitter probes are mechanically identical to receiver probes.

5. The positioning system as claimed in claim 1, wherein the transmitter probes are mechanically not identical to receiver probes.

6. The positioning system as claimed in claim 1, wherein the electronics in transmitter probes are different from the electronics in receiver probes.

7. The positioning system as claimed in claim 1, wherein the PZT crystal in transmitter probes are different from the PZT crystal in receiver probes.

8. The positioning system as claimed in claim 1, wherein the probes are adapted such that the waves are transmitted into a conical wave guide and the end of the wave guide is either pointed or annular.

9. The positioning system as claimed in claim 1, wherein the probe transmits waves which will manifest a point source or an annular line source on the component.
